(19) United States
(12) Patent Application Publication
(10) Pub. No.: US 2012/0284258 A1
(43) Pub. Date: Nov. 8, 2012

(54) SYSTEMS, METHODS, AND COMPUTER PROGRAM PRODUCTS FOR GENERATING RELEVANT SEARCH RESULTS USING SNOMED CT AND SEMANTIC ONTOLOGICAL TERMINOLOGY

(75) Inventor: Justin Liu, Oakville (CA)

(73) Assignee: University Health Network, Toronto, ON (CA)

(21) Appl. No.: 13/510,180

(22) PCT Filed: Nov. 17, 2010
(86) PCT No.: PCT/CA2010/001831

§ 371 Date: Jul. 26, 2012

Related U.S. Application Data
(60) Provisional application No. 61/262,025, filed on Nov. 17, 2009.

(51) Int. Cl. G06F 17/30

(52) U.S. Cl. 707/722; 707/E17.014; 707/E17.059; 707/E17.002

(57) ABSTRACT

Methods, systems, and computer program products for searching clinical terminology databases, and more specifically systems and methods for searching structured terminology databases that possess structures for terminology synonyms and semantic parent concept relationships—such as the Systematized Nomenclature of Medicine—Clinical Terms (SNOMED CT) data standard—are provided. This involves interfacing with the database using an application program interface to enable communication between the database and a search module, and searching the database using the search module to generate an ordered list of database records by defining a search string, retrieving database records from the database by matching terms associated with concepts in the database to the search string, and retrieving the database records for the concepts associated with the matched terms. The retrieved results can be ordering based upon a relevancy criterion.

### FIELD

The present invention relates generally to systems and methods for searching clinical terminology databases, and more specifically to systems and methods for searching structured terminology databases that possess structures for terminology synonyms and semantic parent concept relationships.

### INTRODUCTION

The Systematized Nomenclature of Medicine—Clinical Terms (SNOMED CT) is a data standard that provides core clinical terminology for electronic health information systems, and is endorsed by the International Health Terminology Standards Development Organization (IHTSDO). In the January 2009 release, SNOMED CT contained more than 350,000 unique concepts organized into a hierarchical data structure according to logic-based definitions and inter-concept relationships. One of the ultimate goals of SNOMED CT is to achieve semantic interoperability between different electronic health information systems, by providing a consistent way of indexing, storing, retrieving and aggregating clinical data contained in electronic health records. In other words, to provide a common platform for enabling electronic health information systems to generate and exchange information according to semantic meaning, and not just the specific form in which the information is recorded. Electronic health information systems can achieve interoperability by integrating SNOMED CT into their application software.

### SUMMARY

In accordance with an aspect of embodiments of the present invention, there is provided a method of searching a database of linked database records representing a plurality of inter-related concepts to generate an ordered listing of database records, each concept in the plurality of inter-related concepts comprising a set of associated terms for the concept and a set of relationships to other concepts in the plurality of inter-related concepts. The method comprises: interfacing with the database using an application program interface to enable communication between the database and a search module; and searching the database using the search module to generate the ordered list of database records by: i) defining a search string; ii) retrieving database records from the database by matching terms associated with concepts in the database to the search string, and retrieving the database records for the concepts associated with the matched terms; and iii) ordering the retrieved database records based upon a relevancy criterion.

In accordance with another aspect of embodiments of the present invention, there is provided a system for searching a database of linked database records representing a plurality of inter-related concepts to generate an ordered listing of database records, each concept in the plurality of inter-related concepts comprising a set of associated terms for the concept and a set of relationships to other concepts in the plurality of inter-related concepts. The system comprises: an interface module configured to interface with the database to enable communication between the database and the data processing system; a user interface for inputting a search string; and a search module linked to the interface module configured to: i) match terms associated with concepts in the database to the search string; ii) retrieve the database records for the concepts associated with the matched terms; and iii) order the retrieved database records based upon a relevancy criterion.

In accordance with yet another aspect of embodiments of the present invention, there is provided a computer program product for use on a computer system to search a database of linked database records representing a plurality of inter-related concepts to generate an ordered listing of database records, each concept in the plurality of inter-related concepts comprises a set of associated terms for the concept and a set of relationships to other concepts in the plurality of inter-related concepts. The computer program product comprises a physical, computer-readable recording medium and computer-executable instructions stored on the recording medium for instructing the computer system to: interface with the database using an application program interface to enable communication between the database and a search module; and search the database using the search module to generate the ordered list of database records by: i) defining a search string; ii) retrieving database records from the database by matching terms associated with concepts in the database to the search string, and retrieving the database records for the concepts associated with the matched terms; and iii) ordering the retrieved database records based upon a relevancy criterion.

These and other features of embodiments are set forth and described herein.

### BRIEF DESCRIPTION OF THE DRAWINGS

A detailed description of various embodiments is provided herein below with reference to the following drawings.

FIG. 1 illustrates, in a graph, the basic organizational structure of a hierarchical database, such as SNOMED CT.

FIG. 2 illustrates an exemplary data structure for individual data records stored within the hierarchical database of FIG. 1.

FIG. 3A illustrates, in a graph, inter-concept relationships between different data records stored within the hierarchical database of FIG. 1.

FIG. 3B illustrates, in a graph, inter-concept relationships between different data records stored within the hierarchical database of FIG. 1.

FIG. 3C illustrates, in a graph, inter-concept relationships between different data records stored within the hierarchical database of FIG. 1.

FIG. 4 illustrates, in a schematic diagram, a data processing system for interfacing with and searching a database to generate an ordered list of database entries, in accordance with aspects of embodiments of the present invention.

FIG. 5A illustrates, in a graph, a process for recursively searching concept nodes included in a search class of a hierarchical database, in accordance with aspects of embodiments of the present invention.

FIG. 5B illustrates, in a graph, a process for searching concept nodes included in a search class of a hierarchical database by pre-determining a transitive closure of the search class, in accordance with aspects of embodiments of the present invention.

FIG. 6 illustrates, in a flow chart, a method for searching a database to generate an ordered list of database entries, in accordance with aspects of embodiments of the present invention.

FIGS. 7A and 7B illustrate, in a flow chart, a method for providing real time (or near real time) search results, in accordance with aspects of embodiments of the present invention.

FIG. 8A illustrates an exemplary flattened data structure for individual data records stored within a hierarchical database, such as SNOMED CT.

FIG. 8B illustrates a further exemplary flattened data structure for individual data records stored within a hierarchical database, such as SNOMED CT.

FIG. 9 illustrates, in a schematic diagram, a networked client-server system for interfacing with and searching a database to generate an ordered list of database entries, in accordance with aspects of embodiments of the present invention.

FIG. 10 illustrates an exemplary interface layout for a client-based search application.

The skilled person in the art will understand that the drawings, described below, are for illustration purposes only, and are not intended to limit the scope of the applicant's teachings in any way.

### DESCRIPTION OF VARIOUS EMBODIMENTS

With the increasing need to establish interoperability between electronic health information systems, and to provide for consistent, reliable and comprehensive recordation of clinical information, platforms such as SNOMED CT take on increased significance. At the same time, there are formidable obstacles standing in the way of wide scale integration of SNOMED CT into application software for electronic health information systems. Two such obstacles are the sheer volume and complex hierarchical structure of clinical terminological information stored in the SNOMED CT database. Fast access and searching of SNOMED CT to retrieve pertinent and meaningful structured terminology as a result can prove challenging. Defining data subsets and extension data for application or area-specific uses of SNOMED CT provides another challenge, as does creating a simple and navigable user-interface for searching SNOMED CT. Yet another obstacle to overcome is the fact that clinical terminology does not necessarily remain current over time, and thus many data records stored in SNOMED CT may no longer be relevant, but at the same time must remain in the database so as not to disrupt existing relationships.

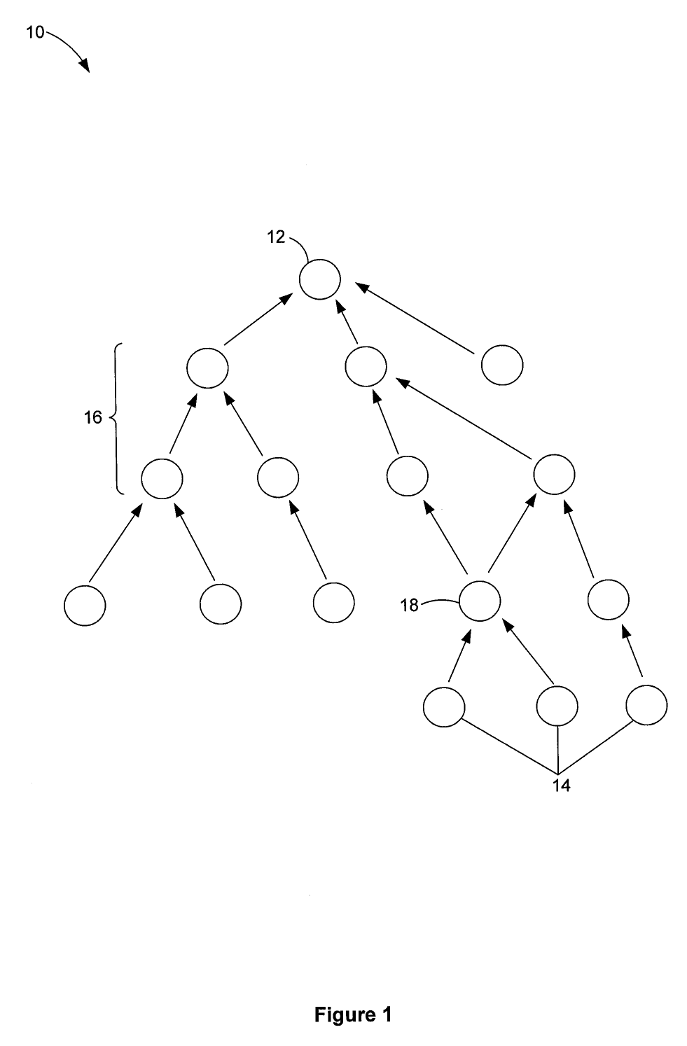

Reference is now made to FIG. 1, which illustrates, in a schematic diagram, the basic organizational data structure of SNOMED CT. Clinical terminology in SNOMED CT is organized into tree-structure 10 comprising a plurality of nodes used to represent unique concepts. In particular, tree structure 10 can be organized into at least one root node 12, as well as leaf nodes 14 and intermediary nodes 16 descending from root note 12. It should be appreciated that tree-structure 10 is hierarchical, inverted, and acyclic. That is, root node 12 defines a top-level category into which leaf nodes 14 and intermediary nodes 16 form sub-categories and sub-sub-categories, hence the tree-structure 10 is hierarchical and inverted. Of course, each sub-category represented by an intermediary node 16 is, itself, a category, and need not be defined exclusively by reference to the top-level category of root node 12. In this case, intermediary node 16 may be taken as a form of “pseudo-root node” to which all its descendent nodes represent sub-categories. As will be described in more detail below, search classes may be defined by selecting any node in tree-structure 10 to serve as a pseudo-root node for the search class, which would then include every descendent node of that root node as well. Tree-structure 10 is also acyclic in the sense that a parent node cannot constitute a sub-category of its child node. The categories and sub-categories represented by the nodes in tree-structure 10 are both ontological and taxonomical.

Tree-structure 10 may comprise more than one root node 12 corresponding to a plurality of top-level categories, though only a single root node 12 is illustrated in FIG. 1 for simplicity. For example, SNOMED CT comprises 19 top-level categories, which include but are not necessarily limited to: clinical finding, procedure, body structure, organism, substance, pharmaceutical/biologic product, specimen, special concept, physical object, physical force, events, environments/geographic locations, social context, staging and scales, and context-dependent categories. These top-level categories represent the broadest taxonomical distinctions made in the SNOMED CT database, and are further refined with increasing specificity. There is also generally no limit to the number of root nodes 12 that are included in tree-structure 10.

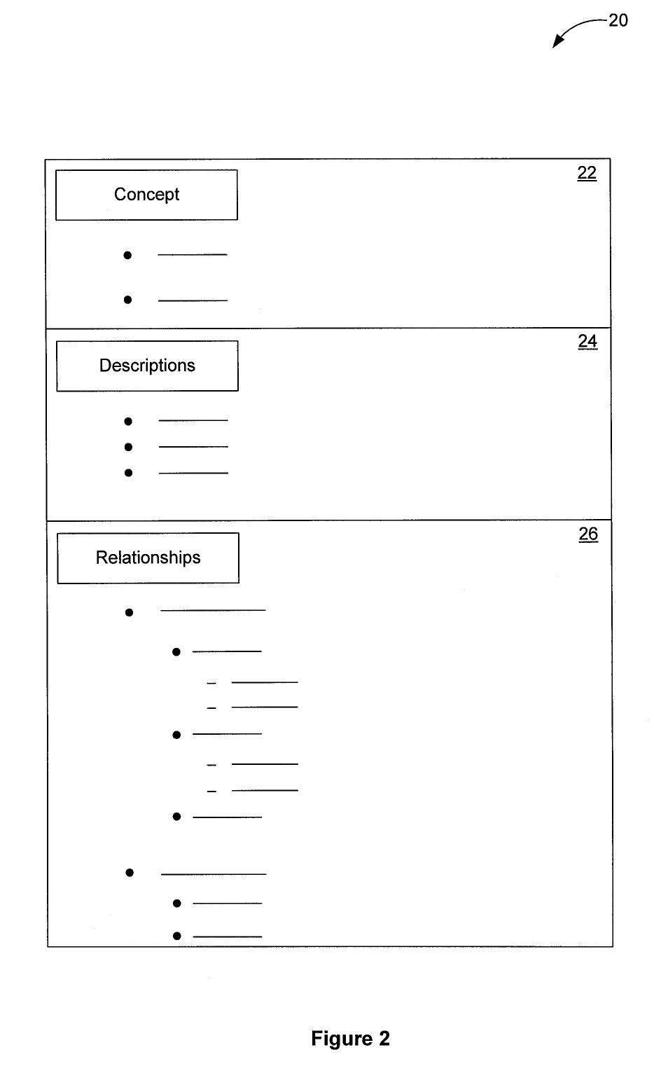

Reference is now made to FIG. 2, which illustrates the basic structure of a concept in SNOMED CT. Each concept in SNOMED CT can correspond to a unique node (root, intermediary or leaf) in tree-structure 10. That is, the hierarchical structure of tree-structure 10 can be taken to represent a plurality of unique concepts importing a certain semantic understanding (the leaves), and a set of inter-relations to other concepts in the tree-structure (the branches). Essentially, concept 20 represents a unit of meaning—a topic, an idea, a process, etc.—for example in the medical health area, as in SNOMED CT.

Representative concept 20 also may have a particular data structure. Accordingly, representative concept 20 can comprise concept field 22, description field 24 and relationship field 26, and can constitute the basic unit of understanding in SNOMED CT. Concept field 22 comprises an entry for a unique conceptID for the concept, which can be a string of digits, for example 6 to 18 digits long, but commonly 8 or 9 digits long. The unique conceptID can be used to keep concepts distinct, and may be used primarily by internal data process, as the conceptID conveys no semantic meaning on its own. Concept field 22 can also comprise an entry for a fully specified concept name, often a formal or scientific name for the concept. In the example given, concept field 22 comprises conceptID 2298006 corresponding to “myocardial infarction (disorder)”. In some embodiments, no other concepts defined in tree-structure 10 may also refer to the same semantic understanding.

Description field 24 of representative concept 20 can comprise entries for terms and logic-based definitions that are associated with the concept. The entries in the description field 24 can include, for example, terms, phrases, synonyms, short forms, etc.—essentially any words or symbols other than the concept's fully specified name—that may be used, by clinicians for example, to refer to the concept. For example, description field 24 can include an entry for the concept's preferred term, as well as additional entries for various synonyms used to describe the concept. Thus, in the example illustrated in FIG. 2, “cardiac infarction”, “infarction of heart” and—perhaps most-well known of all—“heart-attack” are all entered as synonyms of the fully specified concept name, “myocardial infarction (disorder).” As alluded to above, associating various synonyms and alternative terms used to describe a concept can provide a baseline for indexing and retrieving health information. Description file 24 of concept 20 links each of these formally different terms to the same substantive understanding. Thus, any reference to any of the synonyms or alternatives terms may then be associated with the unique concept.

Relationships field 26 can comprise entries for different inter-concept relationships of concept 20. For example, SMOMED CT defines at least two classes of inter-concept relationships. A first type is the “IS-A” relationship, which provides the basic inter-nodal linkages in tree-structure 10 between parent and child nodes, i.e. the branches. According to the IS-A relationship, the child node “is a” type of the parent node, in other words is a more particular instance of the concept defined in the parent category. It follows than that the children nodes of a given parent node represent all particular instances of the parent node. The IS-A relationship also accounts for the inverted nature of tree-structure 10. For example, as illustrated in FIG. 2, myocardical infarction is each of a structural disorder of the heart, an injury of anatomical site, and a myocardial disease. It should be appreciated therefore that if concept 20 were to be included in tree-structure 10, it would have three linkages to a corresponding three parent nodes, one for each IS-A relationship entered for concept 20. Intermediary node 18 in FIG. 1, for example, has two linkages to a corresponding two parent nodes.

A second type of inter-concept relationship that may be defined in tree-structure 10 is the “attribute-value” relationship. This second type of relationship can be used to define necessarily true, existential connections between concepts in different categories or sub-categories. In other words, the attribute-value relationship could provide horizontal linkages (not shown in FIG. 1) in tree-structure 10 between peer or other-related nodes. As the name suggests, an attribute-value relationship between two concepts particularizes one of the two concepts in terms of an attribute of the other. For example, one concept may be a cause of the other, or a cure or a form of treatment, or a geographical location in which the concept is especially relevant, and so on without limitation. Any number of attribute types may be defined, and any number of associated values may be specified. The IS-A and attribute-value relationships together can define a comprehensive set of linkages in tree-structure 10, though in other embodiments additional inter-concept relationships may also be defined.

Entries for allowable qualifiers of concept 20 are also included in relationship field 26. Qualifiers can be used to further particularize the concept 20, but in a way that does not involve defining a new, unique concept. For example, eligible qualifiers for “myocardial infarction (disorder)” can include “onset”, “severity”, “episodicity” and “course”. Concept qualifiers may be useful to provide more pertinent searching and data sorting of concepts stored in tree-structure 10.

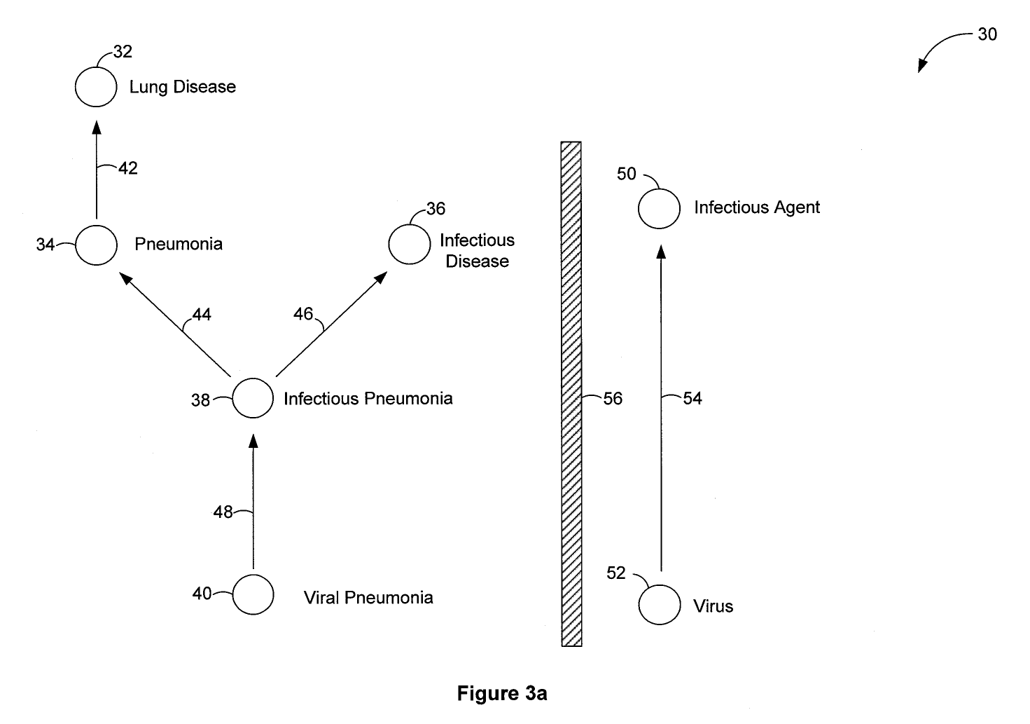

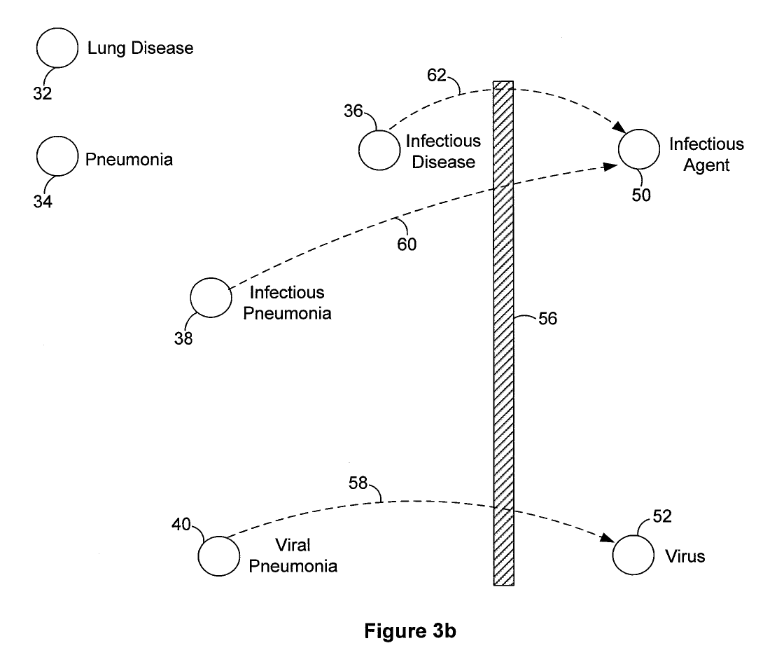

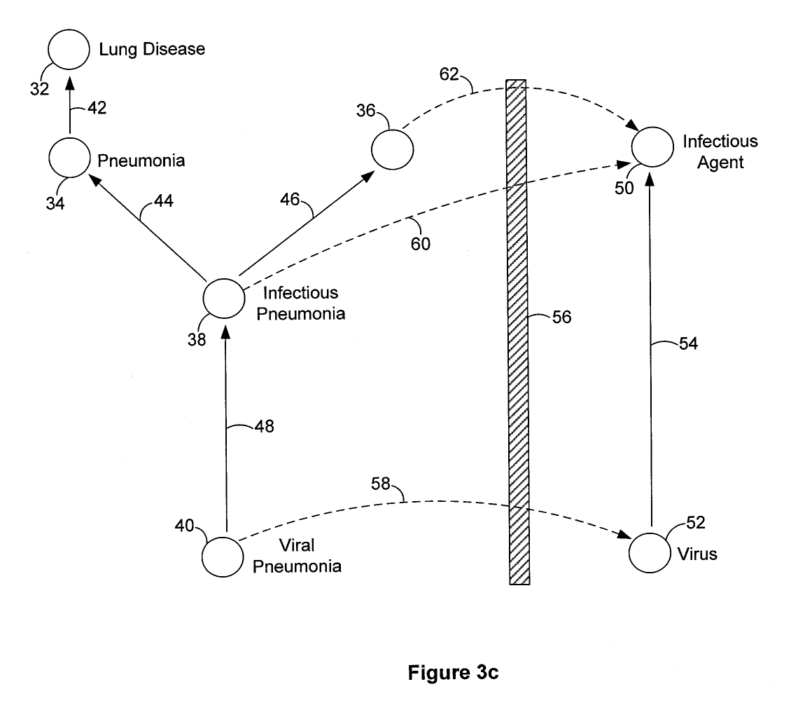

Reference is now made to FIGS. 3A-3C, which illustrate, in graphs, inter-concept relationships for a portion 30 of tree-structure 10. As seen, for example in FIG. 3A, portion 30 comprise node 32 (lung disease), node 34 (pneumonia), node 36 (infectious disease), node 38 (infectious pneumonia) and node 40 (viral pneumonia). Portion 30 also comprises a plurality of IS-A relationship for those nodes. For example, pneumonia is a form of lung disease according to relationship 42, infectious pneumonia is both a form of pneumonia according to relationship 44 and a form of infectious disease according to relationship 46, and finally viral pneumonia is a form of infectious pneumonia according to relationship 48. Portion 30 also comprises node 50 (infectious agent) and node 52 (virus) related by relationship 54. Accordingly, virus is a form infectious agent. Separator 56 is included to indicate that nodes 50 and 52 are sub-categories in a different top-level category, relative to nodes 3-40. In other words, the two sub-sets of nodes descend from different root nodes.

As seen in FIG. 3B, for example, portion 30 may also comprise additional attribute-value relationships 58, 60 and 62, which illustrate causative relationships in FIG. 3B. Accordingly, virus (node 52) is a causative agent of viral pneumonia (node 40), while infectious agent (node 50) is a causative agent of both infectious pneumonia (node 38) and more generally all infectious disease (node 36). It should be appreciated that the attribute-value relationships 58, 60 62 cross over separator 56 because this type of relationship may be cross-categorized. In this respect, relationships 58, 60 and 62 would be unlike the IS-A relationships illustrated for example in FIG. 3A. For completeness, FIG. 3C illustrates portion 30 of tree-structure 10 with both relationship types included.

Different and wide-ranging application software may extend its own functionality by integrating a large terminological database into its own application data or processes. For example, application software in the electronic health information sector may extend its functionality by integrating the SNOMED CT database. To illustrate more concretely, a hospital or larger healthcare network may wish to standardize its record keeping using clinical terminology archived in SNOMED CT. That way, different electronic health records relating to the same affliction or disorder may be associated together, even if the terms or phrases entered into the record itself differ. Thus, it would be possible to recognize, for example, that a particular patient has a family history of a certain disorder, even though that disorder was recorded differently in each different record. The clinical terminology of SNOMED CT provides a common semantic understanding for penetrating the various different forms in which healthcare information is recorded.

As another example, a particular hospital may wish to capture clinical data in a structured form. Using an application that searches a SNOMED CT database enables a higher probability of a user selecting a coded result, because the size of SNOMED CT is much larger than any local terminology database that the hospital would have to develop and maintain locally.

As another example, a particular hospital may wish to document the number of different instances of a certain disease that it treated within the last year. If every clinician working in the hospital uses different words or terms or short hands in the health records to describe the disease, then it could potentially become quite laborious to sift through the records to associate different instances of the same disease in order to produce an accurate estimate. However, if the electronic health system were to interface with a clinical terminological database with semantic relationships, such as SNOMED CT, the process of semantic association would become at least somewhat automated, and consequently would require less time and effort. These and other uses for application software capable of interfacing with terminological databases exist.

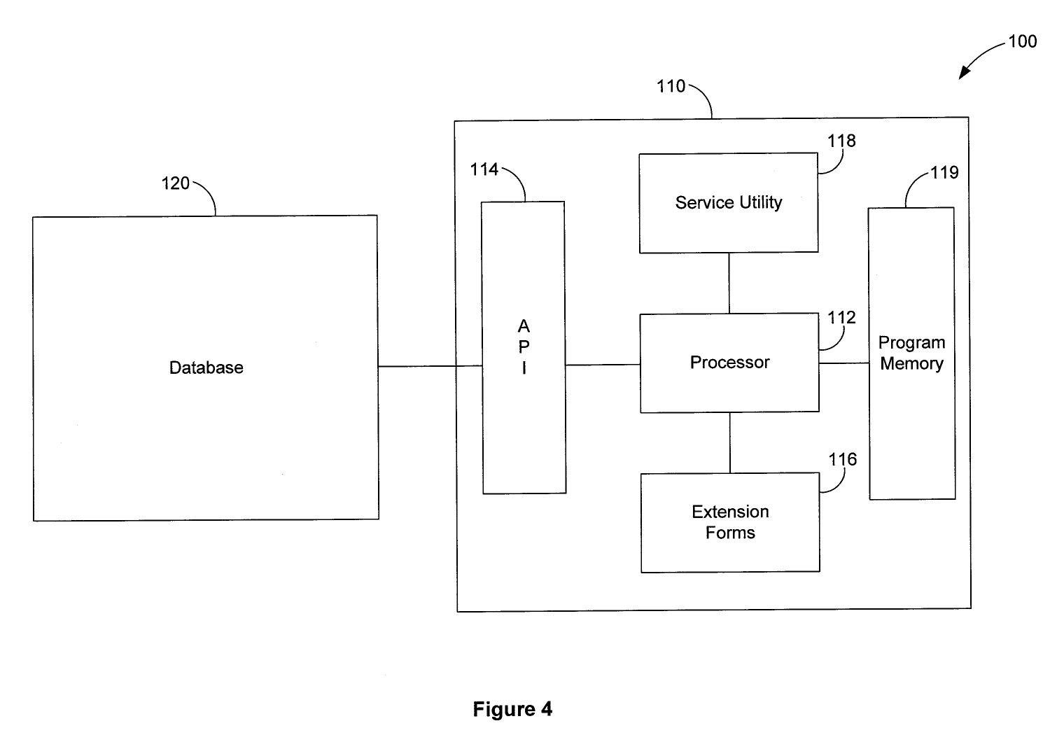

Reference is now made to FIG. 4, which illustrates, in a schematic diagram, a data processing system for interfacing with and searching a database to generate an ordered list of database entries, in accordance with aspects of embodiments of the present invention. The system 100 comprises application program 110 and external database 120, which may be the SNOMED CT database. Those skilled in the art should appreciate, however, that according to the described embodiments, application software 110 may also be adapted for use with other suitable databases organized, like SNOMED CT, according to a hierarchical, ontological structure. The interface and search methods described herein in the context of application program 110 are not limited only to the SNOMED CT database, and may with suitable modification be compatible with these other database structures as well. All embodiments of application software 110 are considered to be within the scope of the present disclosure.

Application program 110 can comprise processor 112, application program interface 114, extension forms 116, service utility 118, and program memory 119. Application program 110 can be implemented as application software written in any suitable programming language for any suitable computer platform, as is known. Processor 112 can be any computer processor compatible with the selected computer platform. Program memory 119 can comprise any suitable storage medium for storing executable instructions used by processor 112 to control operation of application program 110 and to perform the search and interface methods described herein. In particular, program memory 119 can comprise a physical (volatile or non-volatile), computer-readable storage medium that stores computer-executions instructions and, without limitation to the following, may comprise static RAM, dynamic RAM, flash memory, magnetic storage devices, optical discs and the like. Those skilled in the art should appreciated that transitory storage media and now obsolete storage media, such as computer cards, may not be suitable types of storage media for device memory 119.

Application program interface (API) 114 linked to processor 112 can be configured to establish an interface with the external database 120. For example, application program interface 114 can be a software module comprising an instruction set for making calls to or requesting data accesses (read/write) and the like to external database 120. As the skilled person would appreciate, application program interface 114 may comprise any or all of routines, data structures, object classes and network communication protocols used to enable electronic communications between the application program 110 and the external database 120. It should further be appreciated that the routines, data structures, object classes and network communications protocols included in API 114 may be written based on the characteristics of database 120, and that different routines, data structures, object classes and network communications protocol may be written to provide an interface with different a different external database 120. From a functional standpoint, application program interface 114 can be thought of as integrating external database 120 within application program 110. Application program interface 114 thereby allows application program 110 to search external database 120 using intelligent search parameters, as will be described below in more detail.

In some embodiments, application program 110 comprises extension forms 116, though in other embodiments extension forms 116 may be omitted from application program 110. Extension forms 116 can be used to extend the core content of external database 120 in at least one of several different ways. More specifically, external database 120 may in some embodiments be created by a third party, the content of which is locked, i.e. restricted to core content only. For example, external database 120 may be the SNOMED CT clinical terminology database. For some end use applications, however, the external database 120 may be insufficient, incomplete or otherwise somehow limited, and it may be convenient to define extension data to be used in conjunction with the core data content of external database 120. Extension forms 116, when included in application program 110, may be used accordingly to define extension data, such as additional data records or relationships between existing data records, used in conjunction with external database 120 to extend its functionality. Processor 112 can coordinate operation of application program interface 114, extension forms 116 and external database 120 so that the extension data stored in extension forms 116 appear as though they were integrated directly into external database 120. Alternatively, application program interface 114 can be configured to coordinate access to external database 120 and extension forms 116 so as to achieve that affect. In some embodiments, extension forms 116 can also be stored in program memory 119.

In some embodiments, extension forms 116 are used to define additional concepts, in other words additional data records for unique concepts that are not included in the core content of database 120. The additional concepts defined using extension forms 116 may have the same data structure as representative concept 20, comprising a conceptID, a fully specified name, logic-based descriptions and terms, including a preferred term and one or more synonyms, as well as inter-concept relationships, including IS-A relationships and attribute-value relationships, and eligible qualifiers where appropriate. In other words, the database records for concepts defined in extension forms 116 can differ from concept 20 only insofar as they are not included in the core content of database 120. Additional concepts defined in extension forms 116 can be used, for example, to create data records for application or area-specific concepts. This may be useful where the existing terminological data in database 120 has become obsolete or outdated, or to cover unproven scientific concepts, and the like, for example.

Extension forms 116 may also be used to define additional data entries for existing concepts. For example, a particular concept may already be included in the core content of database 120, yet it would be useful to include additional synonyms for the concept to fit the particular end-use application. Extension forms 116 can be used to extend the content of database 120 by creating entries for the additional synonyms that, functionally speaking, appear to have been included in the core content of database 120, even though in fact the entries exist instead in extension forms 116. Similarly, extension forms 116 can also be used to create entries in existing concepts for additional inter-concept relationships. Thus, it is possible to define additional attribute-value, or perhaps even additional IS-A, relationships for existing concepts. It would by extension also be possible to define additional relationships between an existing concept in the core content of database 120 and a newly defined concept in extension forms 116. In general, extension forms 116 can be used to define additional data for any aspect of representative concept 20, which would include additional data entries not discussed in detail herein. These additional data entries may in particular be useful for searching database 120 and other related purposes. For example, eligible qualifiers, inferred relationships, number of words in the preferred term, and so on can be defined and be made fully accessible.

Extension forms 116 can also be used differently to extend the core content of database 120. Rather than defining additional content (either additional unique concepts or additional data entries for existing concepts), extension forms 116 can be used to define explicit class or data subsets of database 120. As described above, database 120 can be organized hierarchically by category and sub-category according to a tree-structure 10. However, these existing categories and concept classifications may be inappropriate for some end-use applications. It may be that, for a given end-use application, the concepts of interest are not organized into the categories and sub-categories defined natively within database 120. Instead it may be that the concepts of interest are belong to a set of cross-categorized and disparately located nodes within tree-structure 10. Accordingly, it may be convenient to define additional, application or area-specific class or data subsets of database 120. In particular, it may be convenient to define cross-categorized subsets of concepts that are not otherwise easily expressible using the existing inter-concept relationships defined for those concepts. Extension forms 116 can be used to define these class or data subsets, which may then be fully integrated into database 120 for accessing and searching purposes, for example by API 114. This point will be discussed in more detail below.

Service utility 118 can be used within application program 110 to provide a user interface and search module for searching database 120 (which may be extended as described in some embodiments using extension forms 116) to retrieve an ordering listing of database records based upon an entered search string. Service utility 118 can be written in any suitable software language and may include a suitably configured graphical user interface. The search module may search and retrieve database records by applying a search algorithm that runs in conjunction with one or more associated algorithm-support functions, including: a search initialization function, a result filtering function, a result ranking function, a post-coordination function, and a search request caching function.

The search algorithm applied by service utility 118 can be used to search external database 120 (and optionally also extension forms 116) for instances of one or searched words contained in a selected search string. Search algorithm can return any data entries (e.g. concepts or entries in those concepts) that matching the search words included in the search string. Thus, the search algorithm may not necessarily retrieve only concepts in which the search words appear, and instead may return as search results any entered fields of concepts, including potentially more than one field entry for the same concept, that matches the one or more selected search terms. The retrieved data entries can then be ordered as an ordered listing of database records.

The search algorithm may be configured, according to a search initialization function, to search the database 120 and/or extension forms 116 based upon additional search parameters other than the selected search string. For example, the search algorithm applied by service utility 118 may be configured to search only for field entries from concepts that are contained within a specified search class. The search class may be a pre-defined concept category in the core content of external database 120, in which case the search class would consist of a particular concept node (which may be a root node, an intermediary node, or potentially even a leaf node) and all of its descendent nodes, if any. Thus, search classes can be defined for “only surgical procedures” or “only bone structures” as but two possible examples. In the special case where the search class is specified by a leaf node, of course, there would be no descendent nodes, as the concept represented by the leaf node would be a bottom-level category. In other cases, however, the search class can be defined to include all the descendent nodes as well. It should be appreciated that a descendent node is relatable to its ancestor node through one or more IS-A relationships.

Alternatively, the search class can be defined to include additional concepts that are related through attribute-value relationships as well. In such a case, the search class may then comprise a pseudo-root node (which may be an intermediary node in tree-structure 10), all descendent nodes of the pseudo-root node, and additional extra-category nodes linked to the descendent nodes by a corresponding attribute-value relationship. Alternatively, the search class can correspond to a class or data subset defined and stored in extension forms 116, in which case the search class can be completely cross-categorized, as desired, to fit a specific end-use application. Thus, the search class can be defined to be restricted only to certain native or user-defined categories, such as “only procedures” or “only disorders” or “only diseases of the heart”, and so on without any limitation to generality of the search class. The search module may retrieve only concepts or data records fitting within the defined search class.

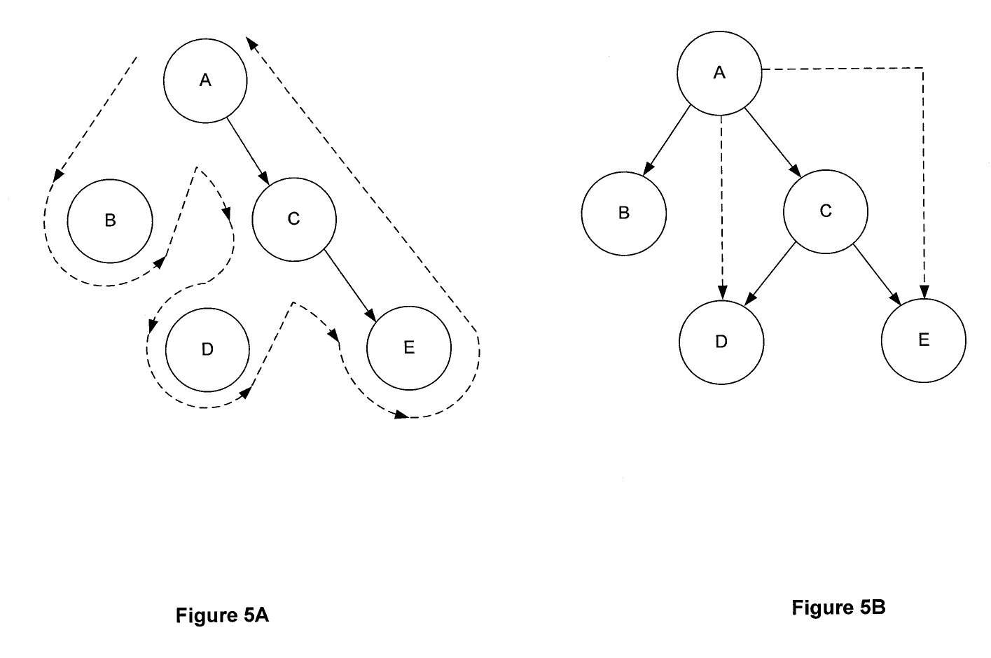

Referring now to FIGS. 5A-5B, the search algorithm applied by service utility 118 may be configured to search every concept node in the search class according to a recursive process. Such a process is illustrated in FIG. 5A. Node A in FIG. 5A serves as a pseudo-root node for a search class, in which are also included descendent nodes B,C,D,E. The search algorithm can search the entire search class for matches to the selected search string recursively by visiting, in a depth-first search fashion, each concept node in the search class. That is, the search algorithm can visit, for each node in the search class, a first child node of that node and all its descendent, for all children nodes of that node until all nodes in the search class have been visited. In the illustration of FIG. 5A, the recursive search process would involve starting at pseudo-root node A, visiting node B and all its children (none in the particular case), then visiting node C and all its children. For the children of node C, the same process is followed by visiting first child node D and its children (none), and then child node E and its children (none). When all descendent nodes are visited, the recursive process returns to pseudo-root node A. The dotted lines in FIG. 5A illustrate the particular sequence in which the recursive search process would visit nodes.

However, to reduce the computational load of the search algorithm, inferred relationships between different concepts in the class can be pre-determined and indexed for fast searching. In this context, two concept nodes can have an inferred relationship where they are related through one or more intermediary nodes. This situation is illustrated in FIG. 5B, in which a transitive closure all relationships within a search class is pre-generated and indexed. Recursive search algorithms may not be the most computationally efficient because the pseudo-root node and certain intermediary nodes will be visited multiple times. For example, in FIG. 5A, node A may be visited 3 times (at the beginning, between nodes B and C, and at the end), and node C may be visited twice (between nodes A and D, and between nodes E and A). Pre-generating a transitive closure involves pre-determining and indexing every concept node included in the search class so that direct links to the descendent nodes are established. The recursive search process may be used to generate the transitive closure. However, since the recursive search is performed only once during initialization and not upon every requested search, computational load savings are possible. This situation is illustrated in FIG. 5B by the inferred, though direct, links to nodes D and E from pseudo-root node A (depicted using the dotted lines). By pre-generating a transitive closure of the search class, nodes A and C are now only visited once. Where the size of database 120 is large (recall that SNOMED CT contains over 350,000 unique concepts presently, and correspondingly over 350,000 different nodes), computational load savings may be substantial. It should be appreciated that the pre-generated transitive closure may also be updated dynamically as the extension data stored in extensions forms 116 is updated (e.g. added, modified or deleted).

The search algorithm may be configured to utilize SNOMED CT's single and dual word key indexes in database 120, also pre-generated. These indexes can be generated using SNOMED CT's single and dual word key index generation algorithm. The single and dual word key indexes can be used as indexing data for new algorithms for faster retrieval of search terms. Specifically, a single word key index may be generated for each individual word in a term, to a maximum of 8 characters. The single word key index generated for a word need not necessarily be the word itself, and may instead be a word stem to account for different variations of the word having different suffixes. As an example, the term “acute myocardial infarction” could have 3 associated single word key indexes, namely “acute”, “myocardi” and “infarcti”. Thus, the word key index “myocardi” would index “myocardial”, but also “myocardium”, “myocardia” and “myocardiac” in turn.

Moreover, a dual word key index may be generated for pairs of individual words in a term containing two or more words. The dual key word index for a pair of words may consist of the first three characters of each word, concatenated together in alphabetical order. In the example above, “acumyo” and “acuinf” may be dual key word indexes. The single and dual key word indexes may be used for faster retrieval of search terms containing two or more words. In some embodiments, the single and dual word key indexes are included in the core content of database 120, while in other embodiments the single and dual word key indexes may be user-defined and stored, for example, in device memory 119 or in extension forms 116. It should be appreciated that the pre-generated single and dual word key indexes may also be updated dynamically as the extension data stored in extensions forms 116 is updated (e.g. added, modified or deleted).

The search algorithm implemented by service utility 118 may also be configured to access a pre-generated word equivalence table of database 120. Where a particular search generates fewer than 5 search results, the search algorithm may then access the pre-generated word equivalence table to retrieve a listing of terms that are equivalent to the words in the search string. A secondary search using the equivalent terms may then be performed in order to boost the number of search results in the final ordering listing.

It will be appreciated by those skilled in the art that one can generate a standard transitive closure and the standard single and dual word key indexes. In certain embodiments, the data structures can be merged and flattened in order to improve the performance of the search mechanism. The hierarchy including both semantic relationships and search indexes is even more complex. A parent concept may have multiple child concepts, which in turn may also have multiple child concepts. Each concept possesses a set of synonyms and descriptions and relationships. Each description possesses a set of single word key indexes and a set of dual word key indexes. In order to implement the search relevance algorithm, search results should preferably be returned from database 120 such that the transitive closure of concept relationships, the properties of each concept and description, and the indexes for each description are combined to return the following properties for each search result: DESCRIPTIONID, TERM, CONCEPTID, CONCEPTSTATUS, PARENTCONCEPTID, PARENTCONCEPTSTATUS, DESCRIPTIONSTATUS, DESCRIPTIONTYPE, INITIALCAPITALSTATUS, WORDCOUNT, TERMLENGTH, DUALKEYINDEX1 to DUALKEYINDEX(N), and SINGLEKEYINDEX1 to SINGLEKEYINDEX(M). It should be appreciated that the relevance algorithm will work providing the above collection of properties is returned for each search term, and an alternate implementation may not choose to flatten the data structure. Those skilled in the art should be able to query the above data model to return a set of search results for a particular set of single and dual word key indexes, and parent concept classification.

In some embodiments, service utility 118 may also include a result filtering function, comprising a filter set of one or more search filters, for filtering search results retrieved by the search algorithm. Inclusion of the filter set in service utility 118 may be useful where the size of the database 120 is very large, resulting in a large number of search results being returned even for relatively specific searches. For health care applications, it may be especially useful to limit the number of search results to only pertinent data records. Accordingly, the filter set implemented by the result filtering function can be used to reduce the number of search results to provide more meaningful search data. Of course, a variety of different filters can be implemented.

For example, a filter can be defined to exclude obsolete or no longer current terms, as defined by the DESCRIPTIONSTATUS and CONCEPTSTATUS properties. As described above, it may sometimes happen that existing terms in the database 120 have become obsolete or, for whatever reason, fall out of use. However, these terms may be left within database 120 so as not to upset existing inter-concept relationships or references to these terms in application software. To illustrate, there may be an old record in an electronic health information system for a particular disorder or condition that now goes by another name. If the data record for that concept were to be culled from database 120, then it may not be possible to semantically associate the old reference to the disorder with its new preferred nomenclature. Thus, it may be convenient or preferable to retain data records in database 120 for obsolete terms for this purpose. At the same time, for present searches of the database 120, it not be preferable to return database records for the obsolete terms that would otherwise be retrieved in a search of the database 120. So as to maintain the relevancy of the search results, service utility may define a filter to exclude obsolete or non-current terms.

Another filter that can be implemented in service utility 118 is a filter to include descriptions that belong to concepts that fall under the umbrella of a pseudo-root node, or grandparent concept, as defined by the PARENTCONCEPTID and PARENTCONCEPTSTATUS properties.

Another filter that can be implemented in service utility 118 is a filter to exclude fully specified names from the search results, as defined by the DESCRIPTIONTYPE property. It will be recalled that every concept 20 has a field in the concept field 22 for the concept's fully specified name, which is useful to uniquely define each semantically different concept. But the concept's fully specified name, though a term of common parlance in the field, may simply not be recorded in a human-friendly or otherwise convenient form (e.g. “myocardial infarction (disorder)” being the fully specified name for the concept of a “myocardial infarction” or simply “heart attack”). Accordingly, a filter can be defined to exclude all fully specified concept names from the search results, thereby leaving only other terms and synonyms that are more frequently used in practice to be retrieved, including common terms, short forms, and the like. Along the same lines, another filter that can be implemented is one to include only a concept's preferred terms in the search results. As a particular concept may have multiple synonyms, but only a single preferred term, applying such a filter will avoid the inclusion of redundant synonyms in the search results, which do not necessarily add to, and may in fact degrade, the quality of the retrieved search data. Application of either or both of these filters can significantly reduce the number of search results that are generated, and at the same time increase the relevancy of the search data, to provide more meaningful search information overall.

Yet another filter that can be implemented is one to include preferred terms only. As part of the SNOMED CT terminology specification, each concept has a “preferred term” in its collection of synonyms, as defined by the DESCRIPTIONTYPE property.

Yet another filter that can be implemented is one to exclude certain pre-defined terms from the search results. Of course, such a filter would be useful where it is known beforehand what information is not of value. Similarly, another filter that can be implemented is one to include and/or exclude terms from the search results based upon such characteristics of the terms as max/min number of words, and max/min numbers of characters. Such filters may again be useful to exclude certain search results that the user knows beforehand to not be relevant. To process search results quickly, these characteristics of the search results may be pre-determined and indexed beforehand for fast processing of the search.

It should be appreciated that each of the above-described filters may be applied not just to the core content stored in database 120, but may also may be applied to the extension data defined in extension forms 116, which along with database 120 is fully integrated into application program 110 by application program interface 114, for example.

Service utility 118 may further comprise a result ranking function used by the search algorithm for ordering the listing of search results according to a relevance criterion. Search results retrieved from the database can be prioritized by the result ranking function based upon a word match rating for each retrieved term with respect to the search string. An initial rating for each retrieved term may be calculated according to:

$$\frac{\begin{matrix}\frac{\# of matched search words in term}{\# of words in search string} + \\ \frac{\# of matched search words in term}{\# of words in term}\end{matrix}}{2} . \qquad ( 1 )$$

It should be appreciated that Eq. 1 averages two separate rating components. The first component of Eq. 1 calculates the percentage of words in the search string that are matched to the term. So for example, if the search string is “advanced lung cancer” then the first component of Eq. 1 would calculate a 66% match for both “lung cancer” and “EGF-R negative non-small cell lung cancer”. In each case, two of three words in the search string are matched to corresponding words in the term. Of course, the level of generality of the two matched terms, as in this case, can be vastly different. It is evident that “lung cancer” is a very general term compared to “EGF-R negative non-small cell lung cancer”.

The second rating component of Eq. 1 calculates the percentage of words in the term that are matched. So in the present example, the second rating component of Eq. 1 would calculate a 100% match for “lung cancer” because every word in the term appears in the search string. However, “EGF-R negative non-small cell lung cancer” would only receive about a 30% match, since many words in the term were not also part of the search string. Thus, the second component of Eq. 1 tends to prioritize terms that more closely match the search string over other terms that are not as good a match. For two strings having the same number of matched words, Eq.1 would assign a higher rating overall to the term that more closely matches the search string. Supplemental ratings can also be assigned to the initial rating to provide a more comprehensive and meaningful ranking. For example, the initial word match rating can be increased if the exact search string is found within the term, as would be the case for the term “advanced lung cancer” if the search string were simply “lung cancer”.

Additionally, if the search string has two or more words, then a boost word match rating can be added to the initial word matching rating to reflect the number of word pairs in the search string that also appear in the matched term. To illustrate, if the search term were “advanced lung cancer”, then “advanced lung” and “lung cancer” are the word pairs within the search string. Every term in the database 120 that includes either “advanced lung” or “lung cancer” could receive a boost word match rating according to:

$$N \times \frac{\begin{matrix}\frac{1}{\# of word pairs in search string} + \\ \frac{1}{\# of words in term - 1}\end{matrix}}{2} , \qquad ( 2 )$$

where N is the number of matched word pairs in the term. Eq. 2 will calculate a higher boost word match rating for terms with fewer words, given the same number of matched word pairs in the search string.

Additionally, if the entire string is found in term, the match rating may be incremented (for example, by 1) to significantly boost its priority.

A search frequency rating can also be assigned for search terms that are more frequently selected, as this may be an indication of that term's particular relevance in an application or field. The search frequency rating can be calculated, for example, as a weighted frequency according to:

$$\frac{\# of times selected}{100} . \qquad ( 3 )$$

Clearly, more popular search terms, which are correspondingly selected more often than less popular search, can be given an increased word match rating using Eq. 3. It should be appreciated that any appropriate weighting factor, and not necessarily just 100, may be used in Eq. 3.

Using Eqs. 1-3, service utility 118 can be configured to generate an overall word matching rating score for each retrieved search term. Search results may then be compiled into an ordered listing of search results, with search results ordered according to higher word match rating. Service utility 118 may also filter out search results for which a minimum word match rating is not satisfied, in order to limit the number of database records that are included in the ordered listing.

After compiling an ordered listing of search results, the results may be traversed and the first occurrence of a unique concept may be tracked. If subsequent results in the traversal share the same concept (hence are synonyms), they may be removed from the search results.

Service utility 118 may also comprise a post-coordination function used by the search algorithm for post-coordinating terms in the search string to generate additional search results. Post-coordination as used herein refers to a process of creating new terms by combining other existing terms. Thus, where the search algorithm fails to locate a term corresponding exactly to a particular search string, post-coordination may be applied in order to generate additional search results, or else re-order existing search results, based on the newly created terms. The post-coordinated terms may be generated based on the search words in the search string, and other terms or words defined in the concept 20, or related concepts. First, the post-coordination function can locate terms in the search results for which every word in the term appears in the search string, though does not match the search string exactly because the search string may contain additional words. The post-coordination function will then try to locate the other words appearing in the search string somewhere else in the concept, or potentially a related concept. As an example, if the search string were “advanced lung cancer”, then the post-coordination function could index through the retrieved search results to locate a data record for the term “lung cancer”, and then perform a check to see if the word “advanced” were listed in the concept as an eligible qualifier, or some other defined value, such as a finding site value or a procedure site value. If the search result can be post-coordinated to the search string, then it may be reordered to the top of the ordered listing of search results.

However, if the search results cannot be post-coordinated to match the search string, then individual words in the search string can be searched in order to determine if any of the words in the search string are themselves concept qualifiers, or other defined values for other concepts. If the search has been filtered based on a parent concept, the parent concept type can be used to constrain the main concept onto which qualifiers are attached. To illustrate, if the search string were “ovarian cancer”, then “ovarian” could be individually searched to determine if it were a qualifier for a concept, and based upon that determined, additional terms could be post-coordinated and included in the search results. Post-coordinated terms generated in this fashion can be stored locally for subsequent verification and use in the application software, for example in future searches. In this way, the search module implemented by service utility 118 can be locally adaptive.

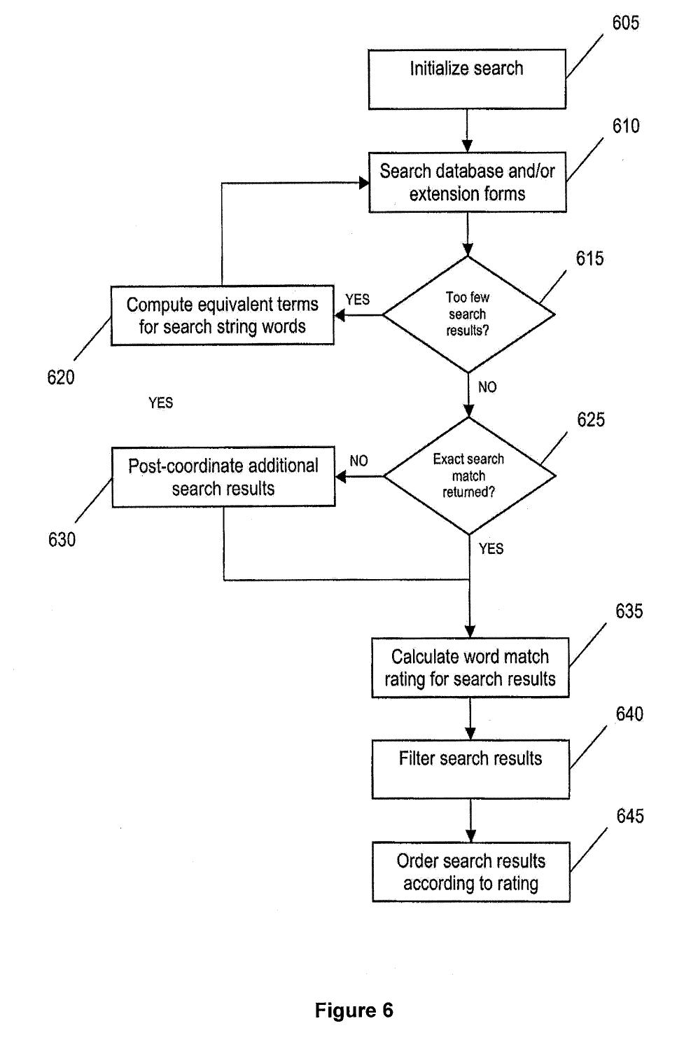

Reference is now made to FIG. 6, which illustrates, in a flow chart, a method for searching a database to generate an ordered list of database entries, in accordance with aspects of embodiments of the present invention. It should be appreciated that method 600 may be performed, for example, by processor 112 of application program 110 accessing a set of computer-executable instructions stored, for example, in program memory 119.

Method 600 commences at step 605, in which a search of database 120 is initialized using the search initialization function of service utility 118. Step 605 may comprise any or all of pre-generating the single and dual word key indexes for the database 120, pre-generating search classes and associated transitive closures for the database 120, as well as pre-generating the auto-complete indexes for the database 120, as described herein. If extension data has been defined and stored in extension forms 116, then step 605 may further comprise pre-generating the single and dual word key indexes for the extension forms 116, updating the search classes and associated pre-generated transitive closures for the database 120 based upon the extension forms 116, as well as pre-generating the auto-complete indexes for the extension forms 116.

Step 610 comprises searching database 120 and/or extension forms 116 by selecting a search string and searching for terms matching the selected search string. In some embodiments, the selected search string is a dual key word index, and step 610 comprises running a primary search of the pre-generated dual key word indexes. Searching based upon dual key word index can result in retrieval of a more refined set of search results. In other embodiments, however, the selected search string is simply a word string, and step 610 comprises running a primary search of the database 120 and/or extension forms 116, optionally within a selected search class, for terms that match the selected search string.

At decision 615, it is determined whether too few search results were retrieved based on the primary search performed in step 610. If too few search results were retrieved, then decision 615 branches to step 620, in which equivalent words are computed for at least one word included in the search string. Step 620 then returns to step 610 to conduct a secondary search of the database 120 and/or extensions 116 (or alternatively the dual key word indexes) based upon the computed equivalent words. If however a sufficient number of search results were retrieved in the primary search performed in step 610, then decision 615 branches to decision 625.

At decision 625, it is determined whether or not the primary and/or secondary searches performed in step 610 retrieved an exact match for the selected search string. If no exact match for the selected search string was retrieved, then decision 625 branches to step 630, in which the post-coordination function is used to generate additional search results. If however an exact matching term was retrieved, then decision 625 branches to step 635.

Step 630 comprises post-coordinating the search string to generate additional search results. As described herein, if an exact match for the search string is not retrieved, then search results containing only matching terms can be identified. For example, if the search string were “advanced lung cancer”, then the search result for “lung cancer” could be identified. Each remaining word in the search string could then be searched to determine if it is a qualifier value, a finding site value, a procedure site value, and so forth for the identified search results. If however no matching qualifier value can be located, then each individual word in the search string can be searched to generate additional post-coordinated search results, again, as described herein. In some embodiments, step 630 can comprise generating, at most, one post-coordinated term per top-level category in database 120. For example, only one “disorder” or one “body structure” could be post-coordinated. Step 630 may further comprise updating the extension forms 116 and auto-complete lists based upon the post-coordinated terms.

Step 635 can comprise calculating word match ratings for the retrieved and/or post-coordinated search results using the result ranking function. An initial rating may be calculated according to Eq. 1, which may then be modified using the boost word match rating and the search frequency rating according to Eqs. 2-3. The result ranking function may also take word equivalence into consideration to adjust the initial word match rating. A final match rating may be generated in step 635 for each retrieved and/or post-coordinated search result. Search results not meeting a certain minimum rating may be eliminated.

In some embodiments, method 600 may further comprise step 640, in which search results may be filtered using the result filtering function. The result filtering function may exclude search results based upon any of the filter parameters described herein.

Step 645 can comprise ordering all search results not filtered out in step 640, or excluded in step 635 for not meeting the minimum word match rating, into an ordered listing of search results. The listing of search results may be ordered, for example, in descending fashion, from highest to lowest, according to their word rating calculated in step 635. Optionally, step 635 can further comprise processing the ordered search results by, for each result in the listing, determining if the search result is a preferred term and, if so, excluding all lower ranking synonyms of the higher ranking preferred term, to produce a more refined listing of search results. After step 645, method 600 may end or be re-initiated.

It should be appreciated that method 600 may be modified, in accordance with aspects of embodiments of the present invention, and that these modifications should be understood as falling within the scope of the present disclose. For example, certain steps of the method 600 may be omitted in some embodiments, while the ordering of the steps of method 600 may be reversed in other embodiments.

The foregoing methods and systems can return results for a single search query, wherein the results have been sorted according to relevance and filtered for redundancy. A common use case would involve the user submitting a single search string, and receiving a set of search results that have been filtered for redundant synonyms and include results that fall under a contextual classification, e.g. only disorders or only procedures, etc. However, in certain applications, it may be desirable to provide support for a richer user interface. For example, it may be desirable to provide supporting algorithms and models to facilitate the generation of search results in real time (or near real time) as text is input into the search field. That is, results based on the search terms could be queried or displayed as the text is input.

Accordingly, in certain embodiments, as part of the search initialization function service utility 118 further comprises a separate library, for example a JavaScript library, to create search fields with auto-complete functionality. The auto-complete library can be made to be accessible in real time as different search strings are entered. As characters in the search strings are entered into a search field, for example, a search request can be dispatched to a terminology server, operating in conjunction with the database 120, to retrieve words having that same initial combination of characters. The retrieved words are presented to the user for selection to auto-complete the search field. To improve the speed of the auto-complete results, special partial single word indexes can be created comprising the first 4 characters of each term longer than 4 characters. For terms having 4 characters or fewer, of course the abbreviation is not necessary, and the partial single word index can just be the term itself. The single word indexes can then be used to auto-complete the search field.

To further improve the performance of the search module, past searches and search results can be cached, for example in device memory 119 or in any other suitable fast memory. In the event that a search request is repeated, rather than re-perform the database search, the search results for that previous search may be retrieved from cache instead. Another option is to limit the scope of a search based on the search string of another pending or recently performed search. For example, if a search is pending or was recently completed for a first search string “diabet”, and subsequently another search request is input for the search string “diabete”, then the pending or cached search results returned for the first search string could be filtered or searched—rather than initiating a new database search—as the results from the first search string would in this example include all results for the second string. However, if a search is pending or was recently completed for the search string “diabete”, and subsequently another search is initiated for the search string “diabet”, the search results from the first search string may include search results that would be included in the subsequent search, but would not necessarily contain all necessary search results. To illustrate, in this case, the term “diabetic coma” would not be within the scope of the pending or cached search results for the initial search string. If none of these methods for improving search response times based on pending or cached searches are applicable, then a new search of database 120 and/or extension forms 116 may be performed. The results may then be cached in device memory 119 in case the search string is repeated at a later point in time.

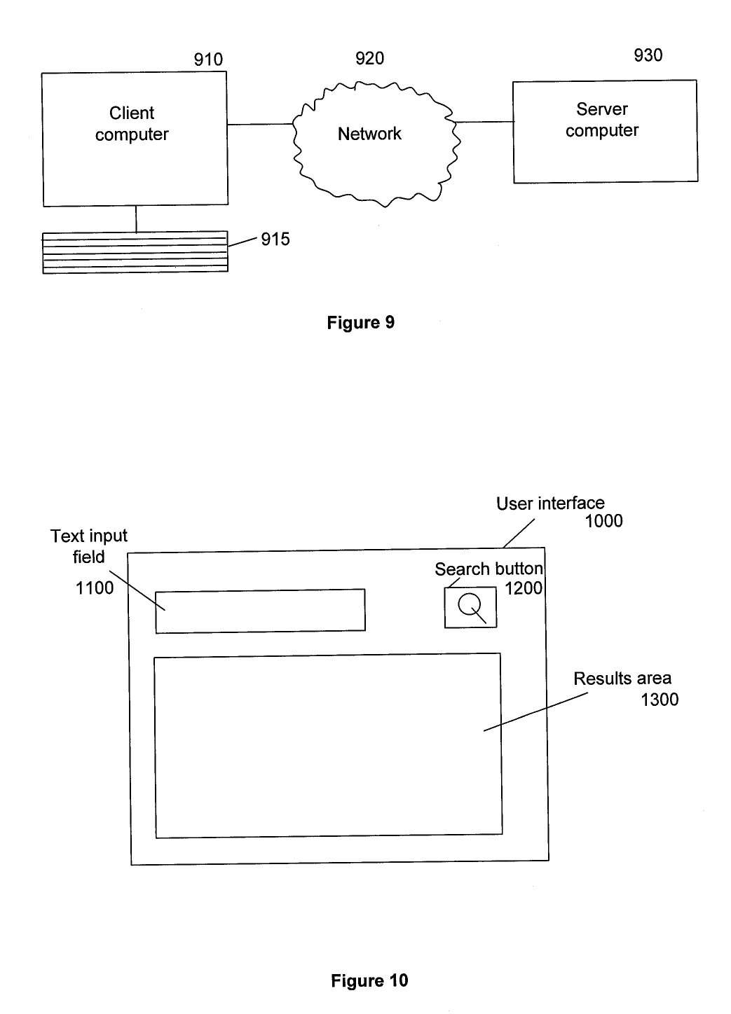

One example of where real time (or near real time) search results may be desirable is in a web application environment. For example, as shown in FIG. 9, a client computer 910 may be in communication with a server computer 930 via network 920 (Network 920 can be a private network or a public network such as the Internet). In certain embodiments, server computer 930 may comprise a data processing system such as the data processing system 100 as previously described. In certain embodiments, client computer 910 may be operable to receive text input via keyboard 915 (or another suitable input device as is known in the art), transmit search queries to the server computer 930 via network 920, and receive search results from server computer 930 via network 920. To facilitate this, in certain embodiments the client computer may be provided with a graphical user interface—such as the exemplary interface shown in FIG. 10—that may comprise a text, input field 1100, a search button 1200, and an area for displaying search results 1300. However, providing real time (or near real time) search results can involve multiple search requests, which may adversely impact one or more of the performance of the system and the computational resources necessary to implement the system. Therefore, it is preferable to reduce the number of search requests that are sent back to the server. It is also preferable to make each search request as fast as possible.

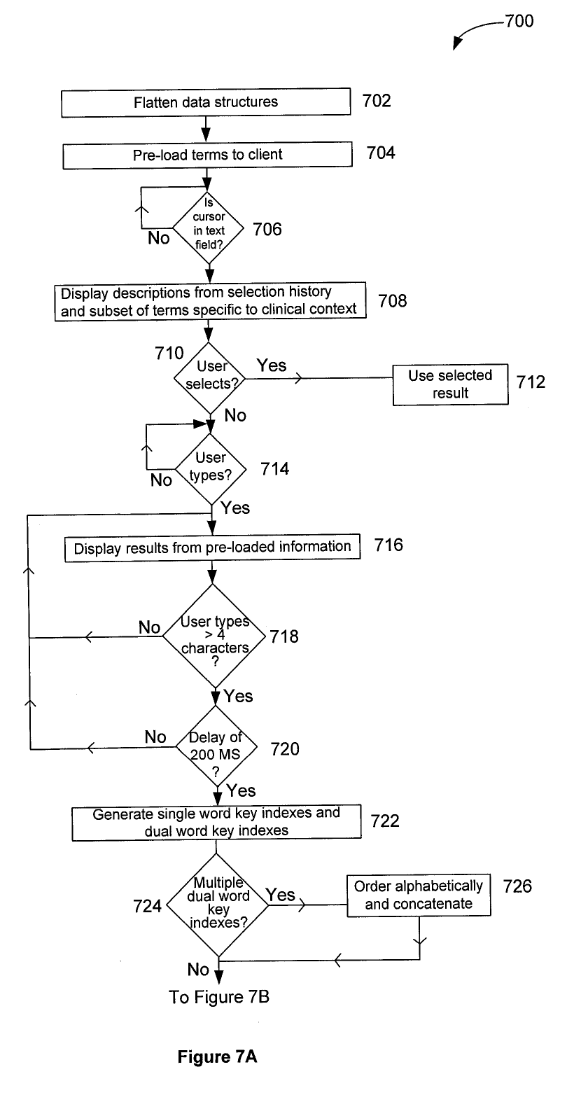

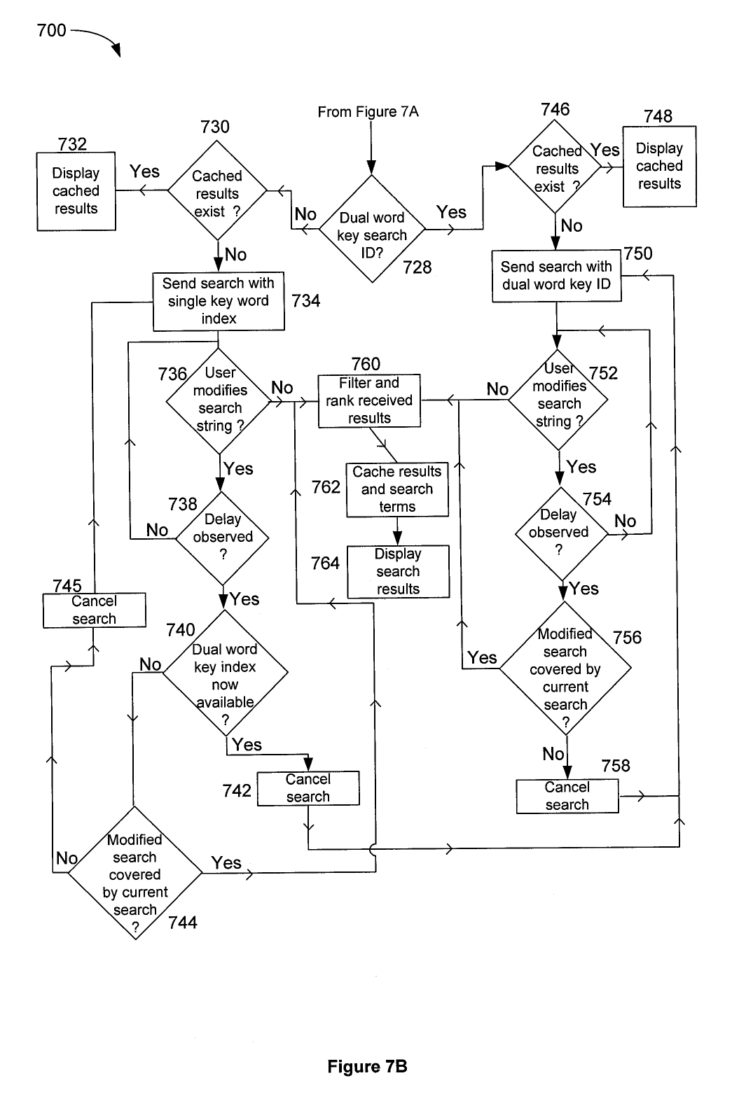

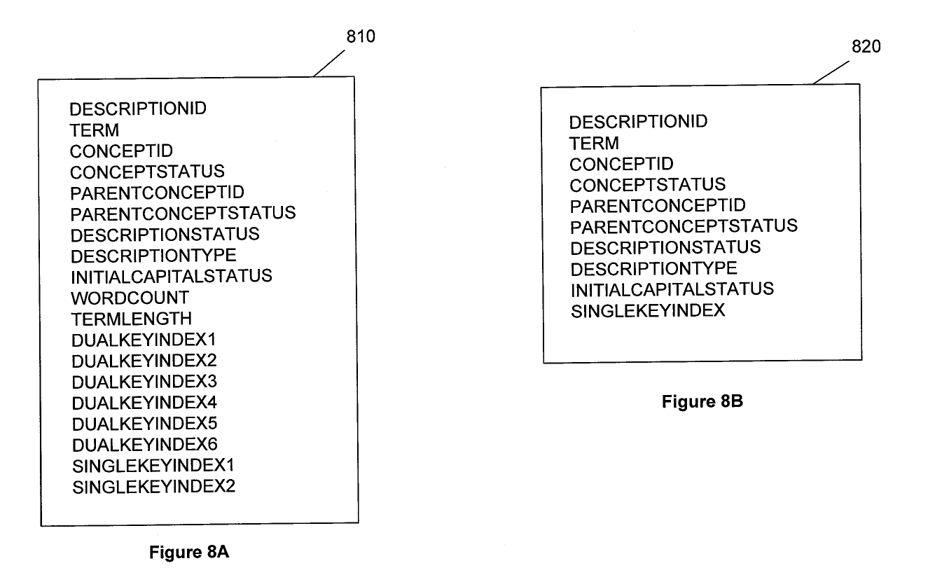

Reference is now made to FIGS. 7 and 8. FIG. 7 illustrates, in a flow chart, a method for searching a database to generate an ordered list of database entries, in accordance with aspects of embodiments of the present invention. It should be appreciated that method 700 may be performed, for example, by processor 112 of application program 110 accessing a set of computer-executable instructions stored, for example, in program memory 119.

Method 700 commences at step 702, where, to make each search request sent to the server as fast as possible, the concept data structure is flattened to a model that encodes each terms' complete parent concept hierarchy and its search index values. For example, FIG. 8A shows an exemplary data structure for SNOMED CT data.

Also at step 702, terms that contain 4 or fewer characters, or acronyms of 4 or fewer characters (e.g. DM—Diabetes mellitus) are optionally, but preferably, flattened and stored in a separate data structure, to create a smaller, faster-to-load table. Such an exemplary data structure for SNOMED CT data is shown in FIG. 8B. This smaller table preferably requires less computational overhead to query, relative to a larger table (such as the table shown in FIG. 8A).

At step 704, certain information is pre-loaded to an application running on a client computer (Such as client computer 910 in FIG. 9). This pre-loaded information preferably includes: all short descriptions (<=4 characters in length) for the concept subtype classification of the search field (e.g. only diseases); where available, all descriptions from a subset that is relevant to the current user/service/application, for the concept subtype classification of the search field (e.g. only diseases); and, where available, descriptions that the current user has recently selected for the concept subtype classification of the search field (e.g. only diseases).

When a cursor is placed in the search field displayed by the client computer (as determined at decision 706), step 708 immediately displays search results generated by the client computer from at least one of the descriptions from the user's selection history and from the subset of terms specific to clinical context (i.e. from information pre-loaded at step 704). If, at decision 710, the user selects one of the displayed results, the method terminates at step 712 without querying a server computer (such as server computer 390 in FIG. 9).

If no results are selected at decision 710, and text input is detected in the search field at decision 714, the local pre-loaded information (e.g. short descriptions, context-specific subset and user history) is searched and results are generated by the client computer and immediately displayed at step 716 and updated as individual characters are added (or removed from) the search field, without requiring a search to be explicitly initiated. The results are matched and filtered, preferably according to the relevance algorithms previously described.

Once the input search string is greater than 4 characters (decision 718) and a specified delay (for example, 200 ms) is observed between input keystrokes (decision 720), single word key indexes (and dual word key indexes, where applicable) are generated from the search string (step 722). Where multiple dual word key indexes exist (as determined at decision 724), the dual word key indexes are ordered alphabetically and concatenated to create a dual word key search identifier (step 726).

Where a dual word key search identifier does not exist (decision 728), the single key word index generated from the search string is compared with locally cached results (as will be discussed in greater detail later) at decision 730. If a cached result set exists for the single word key index generated from the search string, the cached search results are selected by the client computer and displayed at step 732. If a cached results set does not exist for the single key word index, a search request with the single key word index is sent to the server at step 734.

After a search request comprising a single key word index has been sent to the server (at step 734), the method monitors the search field displayed on the client computer to determine if the search string is being modified. Where the input search string is modified (decision 736) and a specified delay (for example, 200 ms) is observed between input keystrokes (decision 738), and if a dual word key search identifier is now available (decision 740), the current search may be cancelled (step 742) and a new search initiated (step 750) using the dual word key search identifier generated from the modified search string. Alternately, even if a dual word key search identifier is not available, if a search for the single word key index generated for the modified search string will not be covered by the results of the current search—For example, where the single key word index sent to the server is DIABE but the new single word key index is DIAB, a search for DIABE does not include all the results for DIAB (decision 744)—the current search may be cancelled (step 745) and a new search initiated (step 734) using the single word key index generated for the modified search string.

Similarly, where a dual word key search identifier exists (decision 728), and if a cached result set exists for the dual word key search identifier generated from the search string (decision 746), the cached search results are selected and displayed at step 748. If a cached results set does not exist for the dual word key search identifier, a search request with the dual word key search identifier is sent to the server at step 750.

Where the input search string is modified (decision 752) and a specified delay (for example, 200 ms) is observed between input keystrokes (decision 754), if the client computer determines that the modified search string creates a different dual word key search identifier (decision 756), the current search may be cancelled (step 758) and a new search initiated (step 750) using the dual word key search identifier generated from the modified search string.

However, if the new single word key index or dual word key search identifier is still covered by the results of the current search (decisions 744 and 758, respectively), the current search proceeds. For example, where the current search is DIABE and the new single word key index is DIABET, a search on DIABE will include the results for DIABET.

When the results of the search request are returned from the server at step 760, the returned results are ranked and filtered, preferably according to the relevance algorithms previously described. Optionally, where a modified search string was detected but it was determined that the results for the new single word key index or dual word key search identifier would be covered by the results of the original (i.e. unmodified) search, the returned results can be filtered based on the modified search string.

Preferably, at step 762, the returned results are tracked or “cached” at the client computer by associating the returned result set with the corresponding single word key index or dual word key search identifier.

Finally, the results are displayed at step 764.

It will be understood to person skilled in the art that certain steps in method 700 may be modified, in accordance with aspects of embodiments of the present invention, and that these modifications should be understood as falling within the scope of the present disclosure. For example, method 700 may not monitor the search field to determine if the search string is being modified once a query has been sent to the server. That is, the method may proceed from steps 734 or 750 directly to step 760. Further, it should be appreciated that the ordering of the steps of method 700 may be reversed in other embodiments.

It should be appreciated that section headings used herein are for organizational purposes only and are not to be construed as limiting the subject matter described in any manner. It should further be appreciated that other variations and modifications of the invention are possible and within the scope of the present disclosure.

1. A method of searching a database of linked database records representing a plurality of inter-related concepts to generate an ordered listing of database records, each concept in the plurality of inter-related concepts comprising a set of associated terms for the concept and a set of relationships to other concepts in the plurality of inter-related concepts, the method comprising:
interfacing with the database using an application program interface to enable communication between the database and a search module; and
searching the database using the search module to generate the ordered list of database records by:
defining a search string;
retrieving database records from the database by matching terms associated with concepts in the database to the search string, and retrieving the database records for the concepts associated with the matched terms; and
ordering the retrieved database records based upon a relevancy criterion.

2. The method of claim 1, further comprising:
augmenting the database with an extension data set stored in a data store linked to the application program interface, wherein the extension data set comprises, for at least one concept in the plurality of inter-related concepts, a set of additional associated terms for the at least one concept; and
searching the database to retrieve at least one database record by matching terms in the extension data associated with concepts in the database to the search string.

3. The method of claim 1, further comprising:
augmenting the database with an extension data set stored in a data store linked to the application program interface, wherein the extension data set comprises an application-specific set of inter-concept relationships defining an application-specific search class of the database, and
limiting searching of the database to generate the ordered listing of database records to enable searching of the application-specific search class.

4. The method of claim 1, further comprising:
determining the relevancy criterion based upon at least one of a number of words in the search string, a number of matched words in the search string, and a number of words in the matched term.

5. The method of claim 1, further comprising:
pre-determining a transitive closure of a search class of the database, the transitive closure comprising an index listing of each concept related to at least one other concept within the search class according to the set of relationships for that concept; and
searching the search class of the database to generate the ordered listing of database records by indexing through each concept in the index listing to identify terms included in that concept that match the search string.

6. The method of claim 1, further comprising filtering database records from the ordered listing of database records by at least one of: excluding non-current terms, excluding terms corresponding to a fully specified name of the concept, and including only preferred terms for a concept.

7. A data processing system for searching a database of linked database records representing a plurality of inter-related concepts to generate an ordered listing of database records, each concept in the plurality of inter-related concepts comprising a set of associated terms for the concept and a set of relationships to other concepts in the plurality of inter-related concepts, the data processing system comprising:
an interface module configured to interface with the database to enable communication between the database and the data processing system;
a user interface for inputting a search string; and
a search module linked to the interface module configured to:
match terms associated with concepts in the database to the search string,
retrieve the database records for the concepts associated with the matched terms; and
order the retrieved database records based upon a relevancy criterion.

8. The data processing system of claim 7, further comprising:
a data stored linked to the application program interface and configured to store extension data used to augment the database, wherein the extension data set comprises, for at least one concept in the plurality of inter-related concepts, a set of additional associated terms for the at least one concept, and
the search module is further configured to search the database to retrieve at least one database record by matching terms in the extension data associated with concepts in the database to the search string.

9. The data processing system of claim 7, further comprising:
a data stored linked to the application program interface and configured to store extension data used to augment the database, wherein the extension data set comprises an application-specific set of inter-concept relationships defining an application-specific search class of the database, and
the search module is further configured to limit searching of the database to generate the ordered listing of database records to searching of the application-specific search class.

10. The data processing system of claim 7, wherein the search module is further configured to determine the relevancy criterion based upon at least one of a number of words in the search string, a number of matched words in the search string, and a number of words in the matched term.

11. The data processing system of claim 7, wherein the search module is further configured to:
pre-determine a transitive closure of a search class of the database, the transitive closure comprising an index listing of each concept related to at least one other concept within the search class according to the set of relationships for that concept; and
search the search class of the database to generate the ordered listing of database records by indexing through each concept in the index listing to identify terms included in that concept that match the search string.

12. The data processing system of claim 7, wherein the search module is further configured to filter database records from the ordered listing of database records by at least one of: excluding non-current terms, excluding terms corresponding to a fully specified name of the concept, and including only preferred terms for a concept.

13. A computer program product for use on a computer system to search a database of linked database records representing a plurality of inter-related concepts to generate an ordered listing of database records, each concept in the plurality of inter-related concepts comprising a set of associated terms for the concept and a set of relationships to other concepts in the plurality of inter-related concepts, and the computer program product comprising a physical, computer-readable recording medium and computer-executable instructions stored on the recording medium for instructing the computer system to:
interface with the database using an application program interface to enable communication between the database and a search module; and
search the database using the search module to generate the ordered list of database records by:
defining a search string;
retrieving database records from the database by matching terms associated with concepts in the database to the search string, and retrieving the database records for the concepts associated with the matched terms; and
ordering the retrieved database records based upon a relevancy criterion.

14. The computer program product of claim 13, wherein the computer-executable instructions further instruct the computer system to:
augment the database with an extension data set stored in a data store linked to the application program interface, wherein the extension data set comprises, for at least one concept in the plurality of inter-related concepts, a set of additional associated terms for the at least one concept; and
search the database to retrieve at least one database record by matching terms in the extension data associated with concepts in the database to the search string.

15. The computer program product of claim 13, wherein the computer-executable instructions further instruct the computer system to:
augment the database with an extension data set stored in a data store linked to the application program interface, wherein the extension data set comprises an application-specific set of inter-concept relationships defining an application-specific search class of the database, and
limit searching of the database to generate the ordered listing of database records to searching of the application-specific search class.

16. The computer program product of claim 13, wherein the computer-executable instructions further instruct the computer system to determine the relevancy criterion based upon at least one of a number of words in the search string, a number of matched words in the search string, and a number of words in the matched term.

17. The computer program product of claim 13, wherein the computer-executable instructions further instruct the computer system to:
pre-determine a transitive closure of a search class of the database, the transitive closure comprising an index listing of each concept related to at least one other concept within the search class according to the set of relationships for that concept; and
search the search class of the database to generate the ordered listing of database records by indexing through each concept in the index listing to identify terms included in that concept that match the search string.

18. The computer program product of claim 13, wherein the computer-executable instructions further instruct the computer system to filter database records from the ordered listing of database records by at least one of: excluding non-current terms, excluding terms corresponding to a fully specified name of the concept, and including only preferred terms for a concept.
